(19) United States
(12) Patent Application Publication
(10) Pub. No.: US 2010/0161432 A1
(43) Pub. Date: Jun. 24, 2010

(54) PATRON EXPERIENCE MANAGEMENT SYSTEM

(75) Inventors: Yuriy Kumanov, Van Nuys, CA (US); Juan Guevara, Corona, CA (US)

Correspondence Address: KNOBBE MARTENS OLSON & BEAR LLP, 2040 MAIN STREET, FOURTEENTH FLOOR, IRVINE, CA, 92614, US

(73) Assignee: Just Enjoy, LLC, Santa Ana, CA (US)

(21) Appl. No.: 12/638,937

(22) Filed: Dec. 15, 2009

Related U.S. Application Data
(60) Provisional application No. 61/122,684, filed on Dec. 15, 2008.

(51) Int. Cl. G06Q 50/00; G01C 21/00; G06Q 20/00; G06Q 30/00; G06F 3/048

(52) U.S. Cl. 705/15; 701/204; 705/26; 705/40; 705/346; 715/835

(57) ABSTRACT

An electronic method of providing a personalized experience to venue patrons, comprising receiving patron data associated with a plurality of patrons; receiving venue data associated with a plurality of venues; receiving, at at least one server, a request from a first patron to view a menu associated with a first venue of the plurality of venues; and generating, using a processor of the server, a personalized menu for display to the first patron based on patron data associated with the first patron and venue data associated with the first venue, the personalized menu including at least one offering for purchase.

### CROSS-REFERENCE TO RELATED APPLICATIONS

The present application claims priority from U.S. Provisional No. 61/122,684, filed Dec. 15, 2008, which is incorporated by reference herein.

### BACKGROUND

According to conventional approaches, patrons of Food & Beverage (F&B) venues such as restaurants place their orders by interacting with a waiter who in turn manually enters the order details into a system such as a Point of Sale (POS) system. Existing systems, such as web ordering systems that allow users to place orders online. However, these systems offer similar experiences generally to all patrons regardless of their personal preferences or characteristics. Thus, there is an existing need for systems and methods that personalize and customize offerings to patrons based on patron-specific information.

### SUMMARY

In certain embodiments, an electronic method of providing a personalized experience to patrons of food and beverage (F&B) venues is provided. The method can include receiving patron data associated with a plurality of patrons. The method can also include receiving venue data associated with a plurality of F&B venues and receiving, at least one server, a request from a first patron to view a menu associated with a first venue of the plurality of F&B venues. In certain embodiments, the method includes generating, using a processor of the server, a personalized menu for display to the first patron based on patron data associated with the first patron and venue data associated with the first venue, the personalized menu including at least one F&B offering. The patron data associated with the first patron can include information relating to previous purchases the patron has made at the first venue.

An electronic method of providing a personalized experience to patrons of food and beverage venues is provided in certain embodiments. The method can include receiving first patron data associated with a first patron, the first patron data indicative of a first preference. The method can additionally include receiving second patron data associated with a second patron, the second patron data indicative of a second preference. In certain embodiments, the method includes receiving first venue data associated with a first food and beverage venue, the first venue data indicative of a first product offered by the first food and beverage venue, and the first venue data also indicative of a second product offered by the first food and beverage venue. The method can include receiving, at a network connection of a server, first menu request data, the first menu request data representing a request from the first patron to view a menu associated with the first food and beverage venue, and the first menu request data also representing a first network address associated with a first computing device associated with the first patron. In some embodiments, the method includes comparing, using a processor of the server, the first patron data with the first venue data to generate first product selection data, the first product selection data representing the first product and not the second product. The method includes formatting the first product selection data to create first menu data in some embodiments, the first menu data representing a first personalized menu descriptive of the first product. Additionally, the method can include transmitting the first menu data to the first network address. The method can further include receiving, at the network connection of the server, second menu request data, the second menu request data representing a request from the second patron to view a menu associated with the first food and beverage venue, and the second menu request data also representing a second network address associated with a second computing device associated with the second patron. In addition, the method can include comparing, using a processor of the server, the second patron data with the first venue data to generate second product selection data, the second product selection data representing the second product and not the first product. The method can also include formatting the second product selection data to create second menu data, the second menu data representing a second personalized menu descriptive of the second product. In some embodiments, the method can include transmitting the second menu data to the second network address.

In certain embodiments, a system is provided for providing a personalized experience to patrons of food and beverage venues, comprising at least one processor. The system includes a first storage in communication with the at least one processor, the first storage storing first patron data associated with a first patron, the first patron data indicative of a first preference, the first storage storing second patron data associated with a second patron, the second patron data indicative of a second preference, the first storage storing first venue data associated with a first food and beverage venue, the first venue data indicative of a first product offered by the first food and beverage venue, and the first venue data also indicative of a second product offered by the first food and beverage venue. The system can include a communication port configured to receive first menu request data, the first menu request data representing a request from the first patron to view a menu associated with the first food and beverage venue, and the first menu request data also representing a first network address associated with a first computing device associated with the first patron. The system can include a menu generation module comprising software instructions stored on the first storage and executable by the at least one processor to compare the first patron data with the first venue data, and to generate first product selection data, the first product selection data representing the first product and not the second product, and to process the first product selection data to create first menu data, the first menu data representing a first personalized menu descriptive of the first product, and to cause the first menu data to be transmitted via the communication port to the first network address.

In certain embodiments, an electronic method is provided for providing a personalized experience to patrons is provided. The method can include receiving, at least one server, a request from a first patron to view a menu associated with a first venue, the request made by a first patron using a handheld device at a location that is remote from the first venue. In certain embodiments, the method can also include generating, using a processor of the server, a personalized menu viewable by the patron on a display of the handheld device, the personalized menu including at least one item offered for purchase. The method can include receiving, at the server, data indicative of at least one purchase selection made by the first patron from the personalized menu. The method may include receiving location information at the server indicating the location of the handheld device. In some embodiments, the method includes determining, using a processor of the server, an estimated time that the first patron will arrive at the first venue.

An electronic method is provided for providing an electronic event planning interface. The electronic method can include receiving profile data associated with one or more first patrons. In addition, the method can include receiving, at a network connection of a server, a request from a second patron to electronically organize an event at a first venue, the request including an indication that the second patron would like to invite the one or more first patrons to the event, and the request including a first network address associated with a computing device of the second patron. In certain embodiments, the method can also include causing at least a portion of the profile data associated with the one or more first patrons to be transmitted to the first network address.

In certain embodiments, a method is provided for providing an electronic method for inviting a group of patrons to a food and beverage venue. The method can include receiving profile data associated with first and second patrons, including preference information for each of the first and second patrons. In certain embodiments, the method can include comparing the preference information for the first patron to food and beverage data representing food and beverage items offered by the food and beverage venue to responsively generate a first personalized list of items to be offered to the first patron. Additionally, the method can include comparing the preference information for the second patron to food and beverage data representing food and beverage items offered by the food and beverage venue to responsively generate a second personalized list of items to be offered to the second patron, wherein the items included in the first personalized list differs from the items included in the second personalized list.

### BRIEF DESCRIPTION OF THE DRAWINGS

Specific embodiments will now be described with reference to the drawings, which are intended to illustrate and not limit the various features described herein.

FIG. 1 illustrates a patron experience management system according to an embodiment of the present disclosure;

FIG. 2 is a flow diagram illustrating a representation of a patron experience management system that can be used in a restaurant setting;

FIG. 3 is a flow diagram illustrating a representation of an embodiment of a patron experience management system in accordance with the present disclosure;

FIG. 4 illustrates an example graphical user interface for a portion of a patron experience management system;

FIGS. 5A-5D illustrate portions of an example graphical user interface for a patron experience management system;

FIGS. 6 and 7 illustrate further embodiments of a patron experience management systems in accordance with the present disclosure;

FIG. 8 illustrates a high-level diagram of an example computing system on which components of an experience management system may be implemented in accordance with certain embodiments described herein; and

FIG. 9 illustrates a high-level diagram of an example experience management database in accordance with certain embodiments described herein.

FIGS. 10, 11 (including 11-1 and 11-2) and 12 (including 12-1, 12-2, 12-3, 12-4, 12-5 and 12-6) illustrate relational database diagrams of an example experience management database in accordance with certain embodiments described herein.

### DETAILED DESCRIPTION

Various embodiments of a patron experience management system (EMS) are disclosed. Some embodiments employ a dynamic repository of customer data to provide a personalized interface to each patron of goods or service providers such as F&B venues and the like, fostering greater loyalty and/or increased profits. For example, some of the systems described herein interface existing venue systems (e.g., POS systems at restaurants) with patrons' mobile devices. The venue and/or patron may have accounts and associated profiles with the EMS.

Certain EMS implementations are described herein with respect to a restaurant context for the purposes of illustration. However, embodiments of the EMS may additionally be compatible with a broad array of venue types including, without limitation, hotels, resorts, and other hospitality oriented venues, casinos or other gaming related venues, and sports or entertainment venues such as golf courses or theaters, or F&B venues such as bars, and the like.

Patrons can provide profile information such as likes, dislikes, demographic information, etc. Moreover, in some embodiments, the management system may record and store information related to the patron over time, such as information related to the patron's purchase history. Venues can additionally provide profile information such available restaurant menu items, location information, and the like. The patron and/or venue profile information may be included in a database, which may be a relational database, an object-oriented database, a flat-file database, any combination of the above, or other data storage structures. Each profile record may be stored in one or more tables, objects or files. Database management applications such as creating and administering a database and database tables, and administering the creating, updating and deleting of records are common and supported by existing database applications such as, for example, MySQL, Microsoft Access, Oracle, Sybase and FoxBase. Those and other database applications provide extensive database management application design tools, simplifying the design of database management applications, and those of ordinary skill understand well how to use the design tools to construct and operate such database management applications, and also how to present queries to extract records associated with particular keywords or whose field information match specified search criteria. Thus, the present invention is not limited by a particular database management application. Using the profile information, the embodiments of the EMS can tailor patron venue experiences in a personalized fashion. Thus, patrons can influence offerings they receive. In a restaurant context, an example experience management system may provide the user a customized menu based on the venues available menu selections and based on the patron's likes, dislikes, previous order history, and so on. Restaurant customers can have streamlined access to their favorite items, for example. Moreover, venues can “know” their customers before they even step in the door in certain embodiments and customize offerings based on their preferences.

The experience management system may further provide patrons and/or venues with interfaces for interacting with the system in beneficial ways. For example, the management system can provide the user with a mobile device interface, allowing the user to interact with the venue via the management system remotely. For example, a restaurant patron can place an order before entering the restaurant. The user may also be able to view other information related to the venue such as nutritional information, ingredients, pictures, video (both pre-recorded and/or real-time video of the current conditions), reviews, and more. Other interfaces may be provided. In the restaurant example, the user may be able to view the menu in the restaurant (e.g., on a venue provided device or display), at a drive-through window, or in some other manner. The management system may provide venues with customized interfaces as well. These interfaces can provide venues with a powerful tool for monitoring information related to patron's (e.g., patron demographic information, feedback, etc.).

The experience management system of certain embodiments also employs location information associated with the patron to enhance the patron's venue experience. For example, the system can use the geolocation of the patron's mobile device (e.g., through GPS or other positioning technology) to trigger certain events or otherwise improve the patron venue experience. As one illustrative example, in the restaurant scenario described above, a patron may enter an order (e.g., over the management system interface on their mobile device), and the experience management system may notify the restaurant employees to begin preparing the order upon detecting that the user is within a predetermined distance of the restaurant.

In the restaurant context, the EMS can provide a number of advantages as compared to conventional approaches. For example, patrons can make more efficient menu decisions using personalized menus and time savings can be achieved.

In some configurations, the management system additionally allows users to share information with other patrons over one of the management system interfaces (e.g., using their mobile device). Generally, the EMS may be configured to restrict sharing of information among patrons to only those patrons who have established a “friend” relationship. Accordingly, the EMS provides a selectable option that allows one patron to send a request to another patron to establish a “friend” relationship. The other patron will receive the request, for example either upon his or her next login to the EMS and/or in an e-mail, and then may select an option indicating acceptance of the request. Such acceptance causes, in one embodiment, the patron ID of the accepting patron to be added to the FRIENDS table of the requesting patron and also patron ID of the requesting patron to be added to the FRIENDS table of the accepting patron. Thus, in one embodiment, a patron may share a variety of different types of information with other patrons with whom he or she has established such a “friend” relationship, or may access certain status information about such friend. For example, one patron may access the EMS and request a FRIENDS menu which provides status indicators for all patrons with whom a “friend” relationship has been established, including, for example, that a friend is “logged out,” “at a particular venue,” or “logged in.” A patron may then select a friend who is indicated as being “at a particular venue” and the EMS provides further options, including accessing a menu, personalized to the friend, showing items available for purchase at the venue being attended by the friend. The EMS permits the patron to buy from the friend's personalized menu an item that will then be provided to the friend by the venue on behalf of the patron, e.g. buy a friend his or her favorite drink. In this manner, and others, patrons may share venue experiences, and may interact and socialize with each other using the EMS.

In yet other aspects, events can be organized using the EMS. For example, patrons and/or venues can organize events involving other patrons or a group of patrons. Events can be planned at EMS capable venues, for examples (e.g., restaurants, hotels, casinos) or other locations (e.g., a patron's home.) For example, the EMS can invite other patrons to events and organize the event according to the personalized EMS profile information associated with the invited patrons. For example, in one embodiment, the patron invites other patrons to a dinner party at a restaurant venue or at his or her home. The EMS 100 allows the patron or the venue to plan and execute the dinner party according to the personalized preferences of the invited patrons. The EMS also permits a patron to define particular groups of patrons, such that sending future invitations to the same group is made more efficient. In one embodiment, the EMS provides as an invitation-related option, a pull-down list of defined patron groups, allowing the patron to select, with a single click, a group of patrons, each of which will receive an event invitation. For privacy concerns, the EMS may require that other patrons “friend” a patron, before the patron is able to select other patrons to add them to a defined group of patrons.

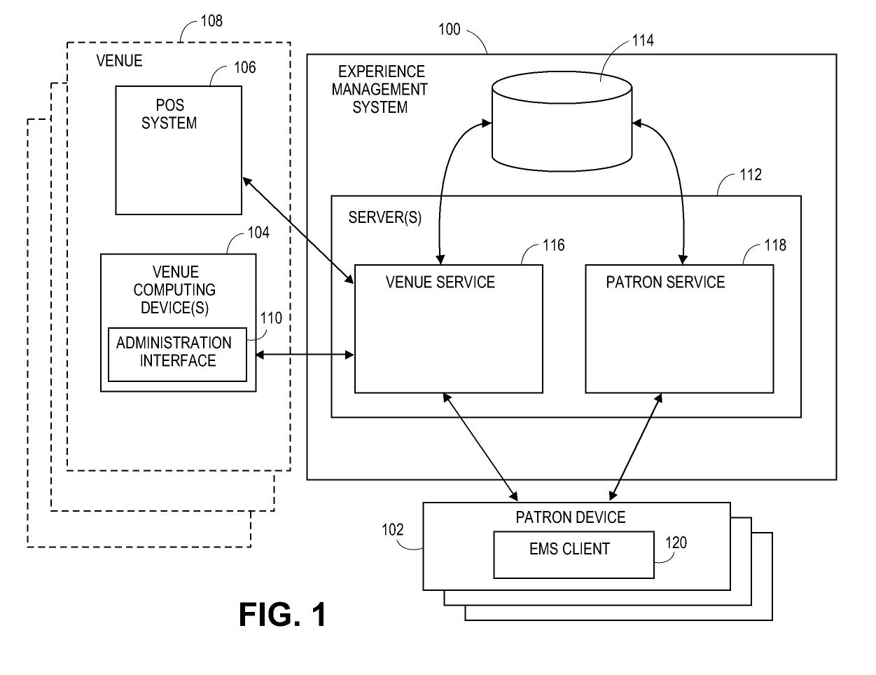

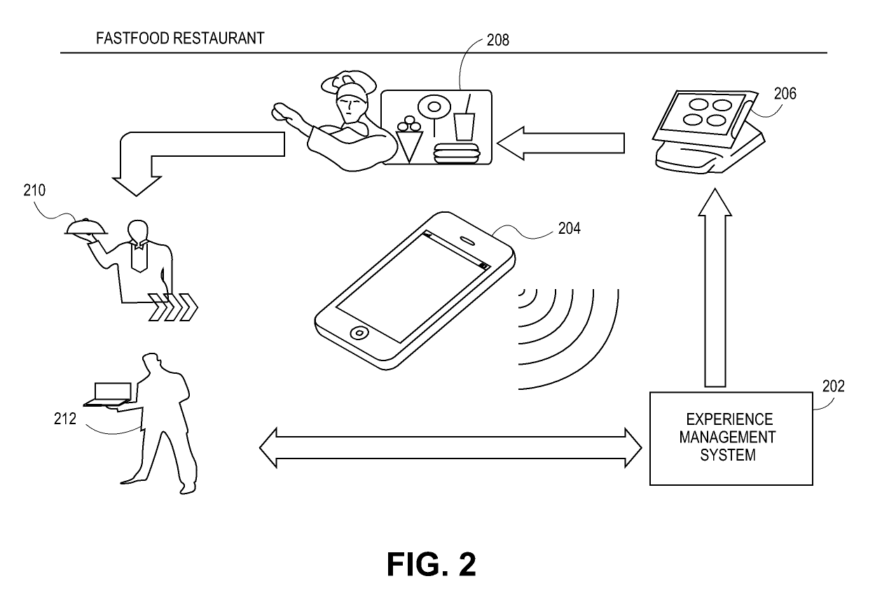

FIG. 1 illustrates an EMS 100, a patron device 102 and a venue computing device 104 and POS system 106 associated with a venue 108. These components can be interconnected by one or more networks. For example, the network can include the Internet, cellular networks, and the like. The patron can be any entity or individual interested in purchasing goods or services from a venue, or generally any non-venue user of the EMS 100. The terms “patron,” “user” and “customer” are used interchangeably herein, and are not to be interpreted as limiting. The venue can be any individual or entity that offers products or services, such as for sale, and can include, without limitation, restaurants, chains of restaurants, hotels, resorts, and other hospitality oriented venues, casinos or other gaming related venues, and sports or entertainment venues such as golf courses or theaters, or F&B venues such as bars, and the like. In some embodiments, the venue can be a user's home. Additionally, in some embodiments, the venue does not offer the products and services for sale and/or is not associated with products and services. For example, a venue can include a location for an event that is scheduled using the EMS 100 (e.g., a meal planned using the EMS 100 by a patron and including one or more other invited patrons), which may or may not involve associated products and/or services.

As illustrated by FIG. 1, there may be more than one patron and associated patron device 102 and more than one venue and associated venue computing device 104 and POS system 106. The patron device 102 can generally comprise any computing device capable of providing a graphical display and/or network access, and in one embodiment comprises a smart phone such as an iPhone, Blackberry or Android. The patron device 110 may additionally include, without limitation, a mobile device such as another type of smart phone, cellphone, etc., a personal computer such as a laptop, notebook. webbook, or desktop, etc.

The venue computing device 104 similarly can include generally any computing device capable of providing a display and/or network access, and in one embodiment comprises one or more personal computers located at the venue location. The venue computing device 104 can additionally or alternatively be any of the types of devices listed above with respect to the patron device 102, or some other type of computing device. Additionally, the venue computing device 104 of some embodiments is not physically located at the venue location, but is located at a remote location. The venue computing device 104 includes an administrator interface module 110 which allows a venue operator such as a manager or other employee to configure the EMS profile associated with that venue.

The POS system 106 can generally include any type of point of sale system and can include any combination of hardware and software capable of any of the following, without limitation: accepting input relating to the goods or services a patron desires to purchase; accepting payment from users; and providing users with an interface for selecting and/or purchasing goods or services. For example, the POS system 106 can include one or more checkout terminals in one embodiment. In various configurations, the POS system can include other computing devices such as a desktop, laptop, notebook, or webbook computers, any of the other computing devices described herein, or any combination thereof. The POS system 106 can be wired, wireless, or a combination thereof. Additionally, the POS system 106 may be compatible with a variety of open or proprietary POS communication protocols. In certain embodiments, the POS system 106 or portions thereof are not physically located at the venue 108. For example, the POS system 106 is a Web-based POS system in some cases and can be run on generally any computing device with an Internet connection and supported browser.

In an example POS system 106 configured for use in a restaurant context, the POS system 106 includes POS software running on one or more touchscreen computer terminals and wireless handheld devices. The POS software can print guest checks, print orders to kitchens or bars for preparation, process credit cards and other payment cards, and run reports. Wireless pagers and electronic signature capture devices may also be used. In a fast-food restaurant, for example, front counter terminals and drive through terminals and associated headsets and speakers can be included. A variety of POS system 106 designs are possible depending on the specific application, as will be recognized by those of skill in the art.

The EMS 100 includes one or more EMS servers 112, such as, for example, web servers. The servers are in communication with an EMS database 114 which stores information relating to the patrons and venues, such as account and profile information. The EMS database may include a relational database, for example, and is a MySQL based database in one embodiment. Generally, the EMS database stores historical data and users preferences, enabling the delivery of a customized experience. Moreover, the EMS 100 and associated database 114 can generally be accessed from anywhere in the world; therefore, the EMS 100 allows personalized service regardless of the location or the venue as long as the venue is EMS capable. In some embodiments, a venue service 116 running on the EMS server 112 is in communication with one or more of the POS system 106, the venue computing device 104, and the patron device 102. A user service 118 running on the EMS server 112 is in communication with the patron device 118.

The venue service 116 can implement a variety of functions. For example, the venue service 116 generally handles and facilitates interactions between the EMS 100 and the POS system 106, venue computing device 104, and/or patron device 102. As an illustrative example, the venue service can allow a venue operator to access and modify the venue's account and associated profile information via the administrator interface 110. The venue service may additionally process and/or compile certain EMS information and provide reports to the venue operator over the administrator interface 110. For example, the venue service 116 may serve a graphical user interface to the administrator interface 110, viewable by the venue operator using a browser of the venue computing device 104. Additionally, the venue service can interact with the POS system 106 to receive and process purchase information, provide venue or patron profile information (e.g., available menu items and patron preferences for customized menu generation), and the like.

In addition to providing a variety of other functions, the user service 118 generally handles and facilitates interactions between the EMS 100 and the patron device 102. For example, the EMS system 100 may serve an EMS client 120 to the patron device 102. A patron may initiate an EMS client session by launching the EMS client 120 and providing login information, for example. In certain embodiments, patrons may additionally be able to login anonymously. For example, anonymous users may be provided a limited subset of EMS functionality.

After login, the EMS client 120 can provide a graphical user interface to the patron, allowing them to interact with the EMS 100. In some embodiments, the EMS 100 serves an on-line EMS portal (e.g., an EMS website), viewable on a web browser running on the patron device 102. In some embodiment, there is no separate EMS client 120 provided, and the patron interacts with the EMS 100 through the on-line EMS portal. The patron service 118 also can allow the patron to access and/or modify the patron's account and associated profile information over such an interface. As is described throughout this disclosure, the on-line portal and/or EMS client 120 can provide a number of functions including one or more of the following, without limitation: (1) a login interface; (2) a personalized menu interface to the patron; (3) a list of available venues; (4) a profile section where the patron can control account information and personal settings; (5) an account management interface for viewing order histories; (6) an interface for editing preferences.

In some embodiments, an open EMS client 120 user session can be cached on the EMS server 112 to preserve the session in the event that the patron device 102 crashes, quits the application, goes out of reception, or otherwise fails. EMS client sessions can remain active for a predetermined period of time.

One or more application programming interfaces (API's) may be used in certain embodiments. For example, API's may be used to interface the EMS client 120 running on the mobile device 102 with the venue service 116, patron service 118, or some other component of the EMS 100. An API may additionally be used to interface the administrator interface 110, the POS system 106, or some other component of the venue 100 with the venue service 116 or some other portion of the EMS 100.

According to certain embodiments, the EMS 100 operates with existing venue hardware (e.g., computing devices 104 and/or POS systems 106). Moreover, the patrons' mobile devices 102 generally do not require additional hardware. As such, the EMS 100 can be integrated into existing infrastructure in a straightforward manner without requiring additional hardware, allowing for rapid, low cost industry adoption.

In some alternative embodiments, a separate server (not shown) is installed at the venue location implementing certain EMS functionality. Such functionality may be implemented on the venue-installed server instead of by the EMS 100, for example. The venue-installed server may be in communication with the EMS 100, for example, and one or more of the POS system 106, existing venue computing devices 104, and/or patron device 104 may be connected to the separate server and communicate with the EMS 100 via the venue-installed server. The venue-installed server may include a database that stores information related to that particular venue such as menu information and the like.

In certain embodiments, access to EMS 100 access is role-based and thus different interface and/or access levels are provided to certain individuals based on the role of the user that is interacting with the EMS 100. Although a variety of other configurations are possible, in one example embodiment, there are four role classes including, in descending order of access level: (1) Super Administrator—The Super Administrator has the highest level of access and can register restaurants with the EMS, provide system maintenance, etc. The Super Administrator may access the EMS 100 directly through the EMS servers 112, for example; (2) Super Manager—The Super Manager is provided access to global EMS statistics, can manage EMS access of other users, but cannot create other Super Managers, for example. The Super Manager may also access the EMS 100 directly through the EMS servers 112; (3) Chain Manager—The Chain Manager role would only be applicable to a chain having multiple venues registered with the EMS 100 (e.g., a chain of fastfood restaurants). The Chain Manager role is generally assigned to an employee of a chain venue and allows the user to create and modify a chain-wide list of menu offerings provided by the chain, distribute the menu to other venues in the chain, register additional chain members to the EMS. The Chain Manager may access the EMS through an administrator interface, such as the administrator interface 110 of FIG. 1, or a separate chain manager interface; and (4) Restaurant manager—The Restaurant Manager role is also generally assigned to a venue employee, and the Restaurant Manager can create and modify the list of menu offerings, view statistics, create other restaurant managers (if applicable), etc. Similar to the Chain Manager, the Restaurant manager may access the EMS through the administrator interface 110, for example.

FIG. 2 is a flow diagram 200 showing an embodiment of how an example EMS 202 can be used in a restaurant setting. The EMS 202 can respond to a download request from a patron device 204 (e.g., a smartphone), such as a smart phone, to serve an EMS client for installation on the smart phone. For example, the EMS 202 can provide access to the EMS client over an on-line portal served by the EMS 202. Alternatively, third-party portals can be used (e.g., the Apple Store) to download the client, or a browser-based interface is used instead of a separate client. The patron may access the EMS 202 with a secure user ID and password, for example, and the EMS 202 generally maintains the patron's profile information, as described.

Patrons of an EMS capable restaurant can access the restaurant's menus offerings while at the restaurant or prior to arrival and can use their mobile device 204 to browse menu offerings, such as personalized menus and the like. In other contexts such as non-restaurant contexts, patrons can browse other offerings such as pictures, products, services, etc. Additionally, in some embodiments, patrons may interact with the menu offerings or other venue offerings through a venue provided interface such as a display (e.g., a mounted LCD display), venue provided handheld device, table-top interface, etc. An EMS 202 interface including a customized menu can be embedded into a restaurant or restaurant chain's existing web site in certain embodiments. In one embodiment, the POS system 206 or other restaurant operated system serves menu offerings or other restaurant information to be presented to the EMS 202, and the EMS 202 pushes such information to the user (e.g., to an EMS client on the user's mobile device), although other configurations are possible.

The EMS 202 generated personalized menu may draw on a wide variety of types of information in generating a customized menu, including, without limitation, the menu offerings available from the particular venue, the time of day, the patron's age, the patron's food preferences, the patron's previous order history, and the like. As another example, the EMS may allow the patron to a level of enjoyment of a particular menu item, such as by providing a numerical ranking or by giving a thumbs-up/thumbs-down type of input. Based on the patron's input, the EMS 202 can determine whether to present the menu item to the patron in the customized menu on the patron's next visit. A “Favorites” button can provide the patron a list of items they have indicated as their favorites or as exceeding a predetermined level of enjoyment. A “Quick order” option may be included providing the patron's previous orders. A “Recommended Dishes” listing can provide the patron a list of offerings that are recommended based on their profile information and ordering history at that venue and/or other venues. Where a chain of restaurants include the same menu options, the menu may at one restaurant in the chain be based on a patron's previous orders or other interactions other restaurants in the chain.

Other type of personalized menus can be generated, depending on the type of venue. As a few examples, a personalized list of gaming options may be presented a casino venue. A hotel patron may be presented list of available hospitality options (e.g., in-room entertainment options, spa services, etc.). A personalized Karaoke song list can be provided at a Karaoke venue. Other personalized menu offerings can include lists of social activities or retail offerings, for example. In certain cases, menus including third-party applications such as software applications can be provided to the patron by the EMS 202. Such applications may be integrated using an API, for example.

Moreover, the EMS 202 may use information related to other patrons that the user is associated with in the EMS 202 social network. For example, the patron may identify one or more other friends who have profiles with the EMS 202 as having similar food tastes to their own. In one scenario, if the identified friend has been to that restaurant or ordered certain menu items, but the patron has not, the EMS 202 generates a menu including items the friends ordered or enjoyed.

In some embodiments, the EMS 202 notifies a patron when one or more friends login to an EMS enabled venue, and allows the patrons to interact. In one example scenario, a patron at a first venue location is notified that a friend is at a second venue location, and the patron can buy the friend a favorite drink, or interact in some other manner.

Additionally, in certain embodiments, the EMS 202 can be used with “friend connect accounts” such as Facebook Connect or Google Friend Connect, providing further social networking capability.

According to some embodiments, the EMS 202 allows chains of venues, or multiple un-affiliated venues to share EMS 202 information with one another. For example, in one embodiment, a first restaurant venue allows a second restaurant to access information related to the patron's ordering history at the first restaurant. The second restaurant may allow the first restaurant similar access to the patron's ordering information at the second restaurant. In other embodiments, the EMS 202 generally makes ordering information publicly available to all venues without requiring permission from the individual venues.

Based on a patron's previous order history or other available information, the EMS 202 may additionally determine additional items to offer to the patron, such as appetizers, drink selections, side orders, and the like, thereby potentially increasing the total value of the order. In various embodiments, such additional items may be presented to the patron in a real-time update after the user selects a first menu item. As one example, a patron at a fast food restaurant may select a hamburger using an EMS menu interface provided on their mobile device 204, and the EMS 202 may prompt the patron as to whether they would like additional items, such as their preferred type of cheese, preferred side order, beverage choice, and the like. In other scenarios, the EMS 202 may present the additional items when generating the initial personalized menu. For example, the EMS 202 may present a customized combination meal option to the patron, such as a cheeseburger including the patron's desired type of cheese, along with their preferred side order and beverage choice.

Using the interface provided on the patron's mobile device 204 or some other interface, the patron is guided through the menu offerings, including favorite or recommended items, special promotions, etc. The patron may select menu options for purchase using an EMS interface on their mobile device 204. The EMS 202 receives the patron's selections and forwards them to the venue's POS system 206.

In some embodiments, the EMS 202 uses the geolocation information of the patron's mobile device to trigger order placement or to provide a notification to venue staff that they should begin food preparation. For example, when a patron is within a certain distance or the patron's expected arrival time is within a certain time period, an electronic message may be sent to a POS terminal or other venue computing device in the kitchen.

In another embodiment, a venue operator inputs the patron's selections and inputs them into a terminal of the POS system 206 (e.g., a cash register or handheld device). For example, the patron may view a customized menu as he or she approaches the cash register, or may be presented a customized menu by a waiter at the patron's seat. The waiter or cashier clerk may then input the patron's selections.

The POS system 206 receives the patron's selections and communicates the selections to venue operators such as preparation staff 208 (e.g., cooking staff) and/or wait staff 210 through the restaurant's POS system 206 (e.g., through a POS computer terminal having a display and mounted in the kitchen or other appropriate area of the restaurant) or through some other interface such as an electronic messaging system. The POS system 206 may further communicate other personalized patron data from the EMS database to the venue operators 208, 210. Such information may include the patron's particular dining preferences including, without limitation, food allergies, whether they drink alcoholic beverages, whether they are a vegetarian or vegan, how the patron likes certain types of meat to be cooked, what kinds of condiments to use, to name a few. Service related information may also be presented to the venue staff 208, 210 as well. For example, the POS system 206 or other interface may provide the venue operators 208, 210 with historical information such as the patron's tipping history, seating desires, complaints, descriptions of previous encounters with the wait staff, and the like.

The servers 210 can then deliver the patron's order and provide customized service to the patron using the information provided by the EMS 202. In one embodiment, a patron can be identified by a venue or by the EMS 202 as a VIP. Using the geolocation of the VIP's mobile device, the EMS 202 can detect that the VIP has entered or is approaching the venue. The EMS 202 can then notify a restaurant manager of the VIP's impending arrival, and the manager can take any appropriate steps, such as greeting the VIP at the door.

At the end of the meal, patrons can pay through conventional means such as by requesting a hard check, or they can charge it through the secured EMS 202 interface (e.g., using a client EMS interface downloaded to their mobile device 202) that stores their preferred payment mechanism and associated information (e.g., credit card info). Diners can also provide feedback and comments about their experience to the EMS 202. The EMS 202 can provide the patron with incentives to use the EMS 202.

Thus, the EMS 202 provides a streamlined ordering process that can increase table turnover. Moreover, workload for restaurant staff is reduced through the automated features provided by the EMS 202, which can provide a number of benefits including allowing staff to focus their efforts more on customer service, reducing the number of staff needed to run the restaurant and thus reducing operating costs, and the like. Moreover, the EMS 202 can help reduce ordering errors. For example, where the patron can input their own ordering selections (e.g., via their mobile device 204), errors in communicating the order to the restaurant staff can be reduced or eliminated.

Additionally, because the restaurant staff has access to a repository of individualized information related to the patron, the staff can make individualized decisions when providing service, reducing mistakes. As a few examples, depending on the types of information available related to a particular patron, restaurant staff may be less likely to serve meat that is not cooked to the patron's preference, serve meals containing food the patron is allergic to, or neglect to put a slice of lemon or ice in a patron's water.

The EMS 202 can allow for targeted content delivery including promotions, games, advertisements, and other marketing related material. In one embodiment, the EMS 202 allows the patron to accrue ‘usage points’ towards future discounts & privileges. Additionally, the EMS 202 can allow venues to market promotional campaigns, provide coupons, etc., over the EMS interface. Because the EMS 202 can provide the venue operators or third party marketers with personalized information related to the patron, the content can be targeted to the specific patrons, improving marketing effectiveness.

The EMS 202 can additionally provide the restaurant or other venue with instant customer feedback, such that the venue can immediately address any issues. For example, the patrons may give feedback using an EMS client on their mobile device, or through one of the restaurant provided devices described herein. Users may be more likely to use the EMS 202 to give feedback than through traditional methods because it is less confrontational than giving oral feedback or writing feedback down on a feedback form.

The EMS 202 can also provide information to venue management 212, such as periodic reports of customer usage, demographic profiles, etc., providing management 212 powerful insights they can use to improve their offerings and service.

Referring again to FIG. 1, the patron's location information may be obtained by the EMS 100 in a variety of ways. For example, the EMS client 120 running on the patron device 102 may communicate the patron's location information to the EMS 100 (e.g., periodically or continually). For example, in one embodiment, the patron device includes GPS capability and forwards the patron's GPS information to the EMS 100. In other embodiments, the EMS 100 receives the location information from another source, such as from the cellular network associated with the patron device 102. For example, the patron device 102 may forward an appropriate device identifier to the EMS 100, and the EMS 100 can provide the device identifier to a cellular network, location tracking system, or other entity which forwards location information to the EMS 100 in response.

The location tracking functionality can be initiated in a variety of ways. For example, in one embodiment, the EMS 100 begins tracking the patron's location when the patron places an order or otherwise indicates that they will be arriving at the venue, or when the patron logs in to the EMS 100.

In some embodiments, the location information is received from the patron device 102 via a web interface. For example, as discussed, the patron device 102 may interact with the EMS 100 via a web interface running on a browser rather than via a separate EMS client 120. In such embodiments, the web interface may request location data from the patron device 102. As an illustrative example, the patron device 102 can be a Blackberry device having GPS capability accessible via an API such as JSR 179. Such devices may include BlackBerry 8800, 8820, 8310 and/or 8110 smartphone devices, for example, and can be configured to enable JavaScript and JavaScript Location support, for example. It will be appreciated that the web interface of the EMS 100 could implement JavaScript executable in conjunction with such a patron device 102 to obtain an indication of the latitude and longitude of the patron device 102. For example, one or more for the following JavaScript functions and/or variables can be used to retrieve the patron device 102 location: blackberry.location.onLocationUpdate( ) blackberry.location.latitude; blackberry.location.longitude; and blackberry.location.refreshLocation( ) It will be appreciated that script-based commands and functions, such as the JavaScript identified above, can, in accordance with known techniques, be associated with a hyperlink or button using, for example, the onclick attribute of a button or hyperlink object. While this example technique is described with respect to a Blackberry device, similar techniques can be implemented for generally other devices (e.g., Apple iPhones or other smart phones or PDAs) such as any mobile device having GPS capability or another appropriate type of locating technology.

The patron's location can be used to trigger certain events such as the execution of an order or a notification of venue personnel, in some cases, such as when the patron is within a certain predetermined distance of the venue, when arrival time is calculated to be within a predetermined period of time, or based on some other criteria.

Estimated arrival time can be determined in a variety of ways. In one embodiment, for example, the EMS 100 directly receives an indication of how fast the patron is moving from the patron device 102 or from some other source. The EMS 100 can combine the speed information with location information to calculate an estimated arrival time. In some embodiments, the EMS 100 provides the patron with an interface for indicating an estimated arrival time, which can be used instead of, or in addition to the location data to trigger events or for other purposes.

In some configurations, the EMS 100 calculates the arrival time from a plurality of location readings. For example, the EMS 100 may receive a first location reading from the patron device 102 at a first time and a second location reading from the patron device 102 at a second time. The EMS 100 can use these readings to determine how far the patron 102 has moved over the time between the first and second readings. From this information, the EMS 100 can calculate how fast the patron is moving and calculate an estimated arrival time. In one embodiment, for example, the patron device 102 accesses the EMS 100 through a web interface rather than through a separate client 120. The web interface presents the patron with a customized menu as described herein through which the patron can select various menu items and eventually place their order. In the example embodiment, the EMS 100 web interface is configured to obtain the patron device 102 location and communicate it to the EMS 100 upon certain patron interactions with the web interface. For example, the EMS 100 web interface may retrieve the patron device 102 location when the patron logs-in, selects a menu item, confirms his or her order, etc., or otherwise interacts with the web interface. For example, the web interface may be configured to call appropriate web functions (e.g., JavaScript functions such as those described above) for retrieving the location of the patron device 102 when the user selects buttons, links or other items on the web interface associated with patron interactions with the web interface. Those of ordinary skill will appreciate that the location information, once obtained by the patron device 102, may be represented by values assigned to parameters that may be transmitted to the EMS 100, for example, via a hyperlink selection. The EMS 100 can use two or more location readings over one or more time intervals to calculate the current travel speed (e.g., distance traversed in a period of time) of the patron and determine an estimated arrival time.

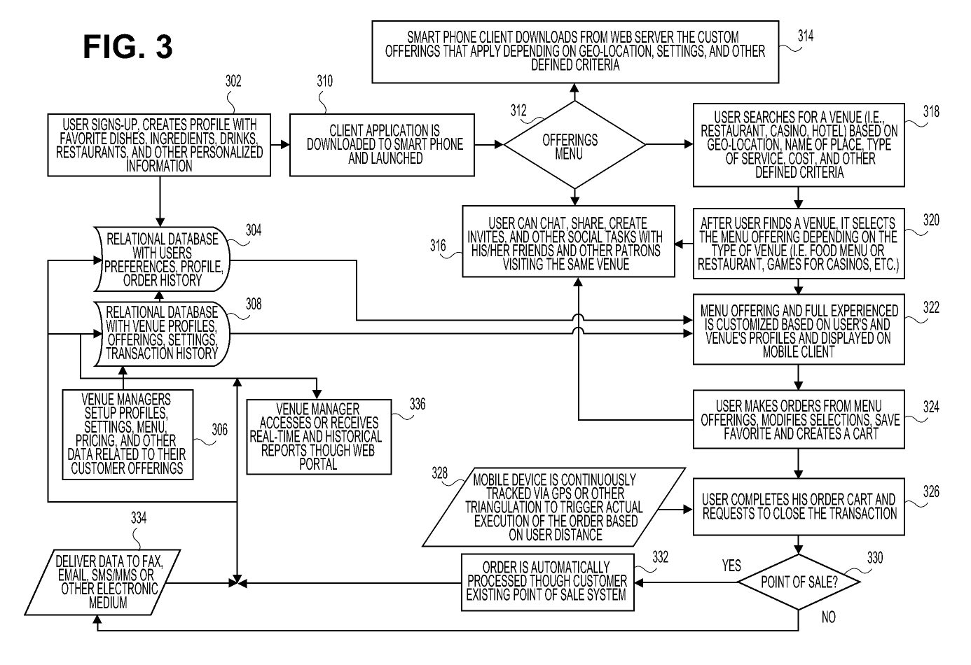

FIG. 3 is a flow diagram 300 illustrating example operation of an EMS according to embodiments described herein. The operational blocks of the flow diagram 300 illustrate possible operations and functionality associated with certain example EMS's. However, one or more of these operational blocks may not be included in other EMS's which are, nonetheless, within the scope of embodiments of the present disclosure, or other operational blocks may be included instead of, or in addition to, the illustrated operational blocks. Moreover, while the operational blocks are described in a particular order for the purposes of illustration, in other configurations or use scenarios the operational blocks may be performed in a variety of different orders.

At operational block 302, a patron can register with the EMS and create a profile including information such as favorite waiters, dishes, ingredients, drinks, restaurants, preferred hotel amenities, preferred seating and other personalized information. Such information can be stored in an EMS database at operational block 304.

At operational block 306, venue operators such as managers or owners can register with the EMS and set up an account, and create a profile including settings, menu, pricing, and other data relevant to their offerings. At operational block 308, this information can be stored in the EMS database.

At operational block 310, the EMS system serves an EMS client application to the patron's mobile device (e.g., a smart phone) and the EMS client application is launched. In alternative embodiments, no special client application is needed, and the patron's device may interact with the EMS system using a common standard application, such as a web browser. At operational block 312, the patron is provided with an EMS menu providing a variety of options. For example, custom offerings can be provided to the patron based on their geolocation, profile, settings, or other criteria and such offerings can be selected by the patron and provided to the user by the EMS system at operational block 314. At operational block 312, the EMS client may further present the user with selections for interacting with other EMS patron's. The patron may select such an option and, at operational block 316, share, create invites, and perform other social networking tasks with his or her friends and/or other patrons, such as those who are visiting the same venue, using the EMS.

Additionally, at operational block 318, the EMS client can present the patron with an option to select or search for a venue. Upon selection of this option, the patron can select this option, search for a venue such as a restaurant, casino, hotel, or other venue. The search can be based on a variety of criteria including the geolocation of the patron, a name based search, type of desired service, price-point, menu, location of the venue and/or other criteria. In one embodiment, the user can select from a list of stored favorite venues.

At operational block 320, once the patron has selected a venue, he or she is presented an interface (e.g., over the EMS client or venue provided interface) having menu offerings.

As shown at operational block 322, the menu can be custom-generated based on the information stored in the EMS database that is related to the particular patron and/or venue, creating a personalized experience for the patron. At operational block 324, the user can interact with the menu in a variety of ways. For example, the user can select particular menu offerings for purchase, modify orders, select favorite items, etc. In one embodiment, the EMS provides an electronic shopping cart. As shown, the EMS also allows the user to share information such as prior experiences, with other patrons or perform other social networking type activities at operational block 316.

At operational block 326, the patron may complete an order and may request that the transaction be completed. In some embodiments, at operational block 328, the location of the patron's mobile device is tracked using GPS, triangulation, or some other mechanism. The patron's location can be used to trigger the actual execution of the order in some cases, such as when the patron is within a certain predetermined distance of the venue or when arrival time is calculated to be within a predetermined period of time.

At operational blocks 330, the EMS detects whether the venue is equipped with a point of sale system. If so, the EMS causes the patron's order to be automatically processed through the POS system at operational block 332. If there is no point of sale system, the order information may be delivered to the venue in some other manner for processing, such as at operational block 334. For example, the data related to the order can be transmitted by fax, email, text message or some other electronic medium. Additionally, the EMS database receives the order information, and updates the patron and/or venue profile information and/or other EMS database information at operational block 304, 308. At operational block 336, the EMS can generate reports, such as real-time or historical reports. For example, the EMS may provide the reports through a web portal.

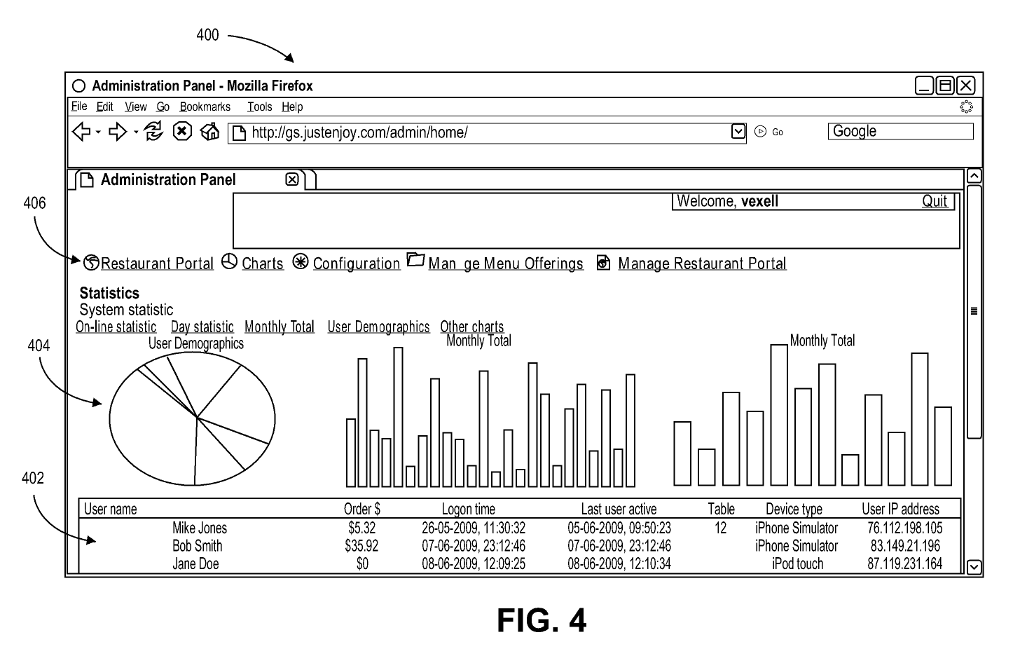

FIG. 4 illustrates a portion of an example graphical user interface (GUI) 400 provided to a restaurant venue for interacting with the experience management system. The GUI may form a part of the administrator interface 110 described above with respect to FIG. 1, for example. In one embodiment, the GUI is a web site or other portal served by the EMS and accessible through a browser running on a computing device associated with the venue. The GUI 400 generally provides the venue operator with a portal for interacting with the EMS.

The web page of the GUI 400 shown in FIG. 4 includes charts and other statistical information related to patron purchases. For example, the GUI 400 includes patron activity information 402 including patrons names, the dollar amount of the patron's order, logon and activity information, a table or seating used by the patron, what type of mobile device the patron used, the patron's IP address. The page shown in FIG. 4 also includes a pie chart 404 which shows a demographic breakdown of patrons, by age, for example. Bar charts 406, 408, show historical income information by date and by month, respectively. In addition to the information presented to the venue operator in the illustrated example, EMS may generally present any other appropriate information stored in the EMS database to the venue operator.

The EMS may provide other functionality to the venue operator through the GUI, such as on other web pages available through a set of links 406. For example, the venue operator may follow a link to a configuration page, which can be used to configure the venue's profile, login information, etc. Another link may provide access to a page which can be used to modify the venue's available menu items, associated prices, etc.

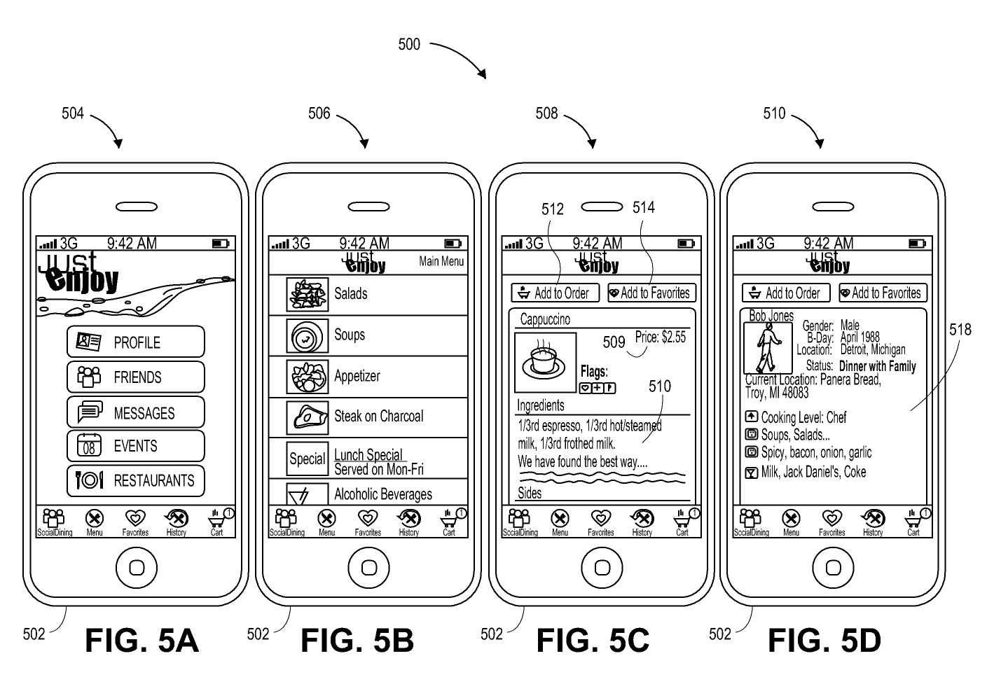

FIGS. 5A-5D illustrate portions of an example GUI 500 provided to a patron for interacting with the experience management system. For example, the GUI can be provided to a user's mobile device 502. The GUI 500 may form a part of the EMS client 120 of FIG. 1, for example. In some embodiments, the GUI 500 runs on a customized software application or module that is downloaded form the EMS to the patron's mobile device. In other embodiments, the GUI may be served to a web browser running on the patron's device.

FIG. 5A shows a home page 504 that may be provided to the patron, after he or she has provided EMS login information, for example. In the illustrated embodiment, the menu 504 includes a plurality of links directing the patron to various portions of the GUI 500, including: (1) a Profile link directing the patron to an area of the GUI 500 where the user can modify his or her EMS profile information; (2) a Friends link directing the patron to another area of the GUI 500 where he or she can interact with other EMS users in a social networking environment provided by the EMS; (3) a Messages link where users can send and receive messages from other EMS users, venues, or other sources; (4) an Events link where the patron can organize, monitor or otherwise view EMS events; and (5) a Restaurants link where the user can search for restaurant venues.

FIG. 5B shows an example menu offering page 506 of a restaurant venue of the GUI 500. For example, in one scenario, the patron selects the Restaurants link of the page of the GUI 500 shown in FIG. 5A. The patron is then directed to another page where he or she can select a particular restaurant venue. The menu offerings page 506 can advantageously be customized according to the patron's profile information. For example, the EMS may process the patron's profile information stored in the EMS database and generate a personalized menu from the available menu options indicated in the venue's profile information, also stored in the EMS database. The customized menu page of FIG. 5B may then be presented to the patron, and the patron can select from a variety of options including categories of menu items (e.g., Salads, Soups, Appetizer, Steak on Charcoal, Alcoholic Beverages), particular offerings (e.g., Lunch Special), etc.

A variety of other types of functions and interfaces may be provided to the patron over the EMS client. For example, patrons may also be able to make reservations with the venue using the GUI 500 in certain embodiments. In some embodiments, patrons can make special requests or provide other details to the venue (e.g., for birthdays, anniversaries, request a type of seating such as a booth, etc.). The EMS client may provide directions and driving details (e.g., by providing embedded access Google Maps or some other on-line mapping software). The EMS client may additionally allow patrons to perform social networking with other EMS users to organize group events and send out invitations.

Once the patron has selected a particular menu item using the GUI 500, the EMS client may then direct the user to a menu item page 508 such as the one shown in FIG. 5C including a detailed description of the item. The description can include price information 509 and other information 510 relating the menu item. For example, information related to the offering such as nutritional content, ingredients, a recipe, and/or marketing information can be included. In one embodiment, if the user has an allergy to a listed ingredient, that ingredient is highlighted. The user may also be able to modify ingredients in some embodiments. Additionally, the example page 508 includes an Add to Order button 512 for ordering the item or placing it in an electronic shopping cart and an Add to Favorites button 515 allowing a patron to add the item to a list of favorite menu items.

FIG. 5D shows a profile page 516 of the GUI 500, which may be accessible by clicking the Profile link of the home page 504 of FIG. 5A, for example. The profile page 516 can present various profile information to the patron and/or provide an interface for the patron to modify their profile information. Example types of information can include, without information, the patron's name, age, birthday, residence, current location, current status, food preferences, food dislikes, interests, contact info, and the like.

While FIGS. 5A-5D show one example GUI 500 which can be provided by an EMS client running on a patron's mobile device, a variety of other configurations are possible in other embodiments. For example, in some cases, additional pages related to other types of venues are provided, such as casinos, hotels, retail venues, and the like.

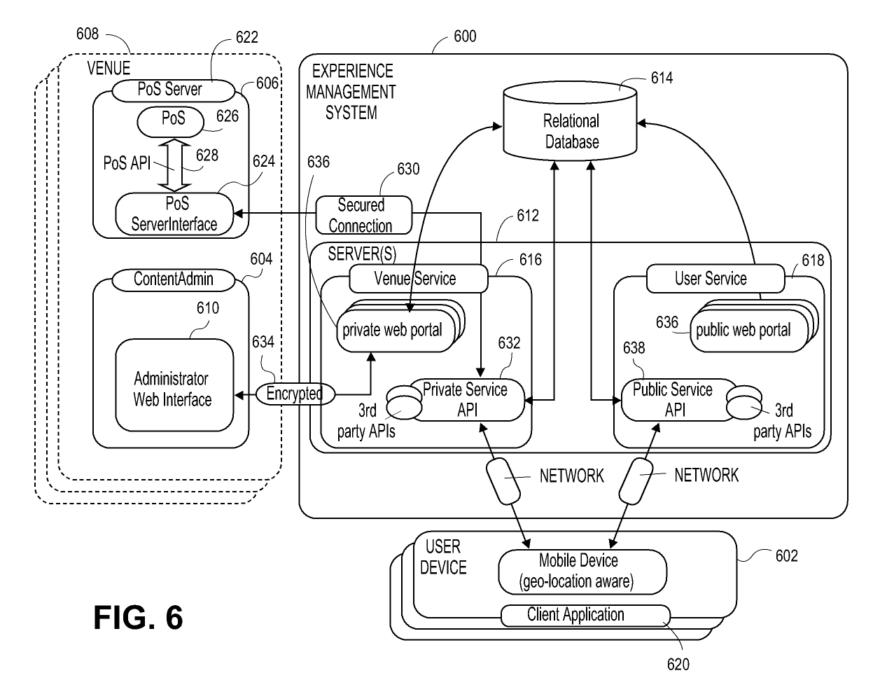

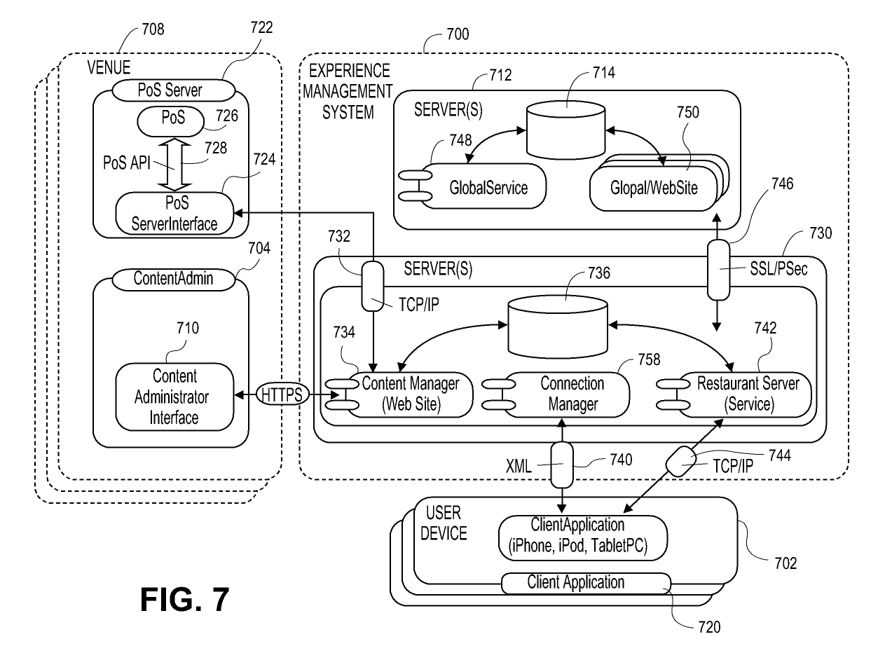

FIGS. 6 and 7 illustrate further embodiments of patron experience management systems 600, 700 in accordance with the present disclosure. FIGS. 6 and 7 each respectively illustrate an EMS system 600, 700 having a relational database 614, 714. The EMS system 600, 700 of each of FIGS. 6 and 7 are additionally associated with a POS system 606, 607, venue computing device 604, 704, which may include an associated administrator interface 610, 710, and a patron device 602, 702, which may include an EMS client application 620, 720. In certain embodiments, these components or other components illustrated in FIGS. 6 and 7 may be similar to or provide similar functionality as the corresponding components shown in FIG. 1.

FIG. 6 illustrates a configuration in which the POS system 606 includes one or more servers 622 and a POS server interface 624 in communication with a POS module 626 via a POS API 628. The POS system 606 is in communication with one or more EMS servers 612 over a secured network connection 630, such as via a POS gateway. A venue service 616 running on the server 612 may include one or more private service and/or third party API's 632. The API's 632 may enable communication between the EMS 600 and one or more of the POS system 606, the patron device 602 and the EMS database 614, for example.

The administrator interface 610 running on the venue computing device 604 can be in communication via an encrypted network connection 634 with the venue service 616. For example, the administrator interface 610 may be configured for communication through a private web portal 636 of the venue service 616.

A user service 618 running on the EMS server 612 can include a public web portal 636 for allowing access to the EMS database 614. The venue service 618 can implement one or more public service and/or one or more third party API's 638, such as for communicating with the patron device 602 and/or EMS database 614.

The configuration of FIG. 7 includes some components which are similar to the EMS 600 of FIG. 6, including a POS module 726, POS API 728, POS server interface 724, and an administrator interface 710, for example. However, in addition to the EMS server 712, the EMS 700 of FIG. 7 includes one or more supplemental EMS servers 730 including a database 736.

The supplemental EMS server 730 may be associated with or physically located at a specific venue or chain of venues, for example. In some embodiments, the supplemental EMS server 730 communicates with the POS 106 via a network connection 732 such as a TCP/IP connection. In one embodiment, the supplemental EMS server 730 serves a content manager service (e.g., a web site) 734 to an administrator interface 710 of the venue computing device 704. Some of the information from the database 736 may be communicated to the administrator interface 710 or modified using the administrator interface 710 via the content manager service 734, for example.

A connection manager 738 running on the supplemental EMS server 730 may be in communication with the patron device 702, via an XML interface 740, for example. A venue service 742 (e.g., associated with a particular restaurant) may be implemented on the supplemental EMS server 730 and can communicate with a patron device 702 through a network connection 744, such as a TCP/IP connection.

The supplemental EMS server 730 may be in communication with the EMS server 712 over a network connection 746. For example, an SSL/PSec connection is used in one embodiment. The EMS server 712 of certain embodiments runs a global service 748 and/or serves a global EMS website 750.

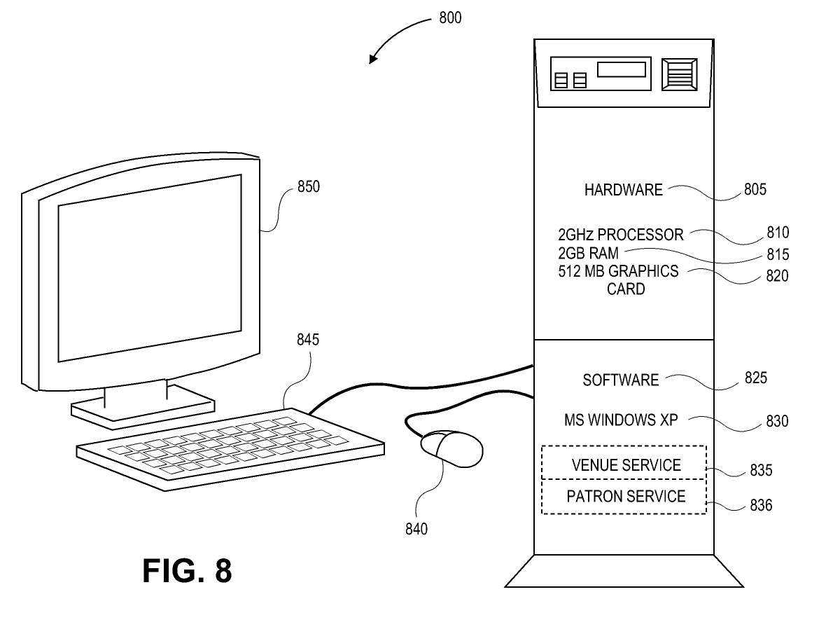

FIG. 8 illustrates a high-level diagram of an example computing system on which components of an EMS may be implemented in accordance with certain embodiments described herein. For example, in certain embodiments, one or more of the servers 112 of the EMS 100 FIG. 1 are implemented on a computing system 800 as described herein. Other components associated with the EMS may additionally be implemented on a computing system compatible with the computing system 800, such as, for example, the venue computing device 104, one or more computing systems of the POS 106 and/or the patron device 102, of FIG. 1, for example.

In certain embodiments, the computing system 800 is, for example, a server computer, although the computing system may also be a personal computer, laptop or some other type of computer. The computing system 800 includes various hardware modules 805. For example, the exemplary computing system 800 includes a central processing unit (“CPU”), which may include a conventional microprocessor. As shown, in one embodiment, the processor can comprise a 2 Ghz processor 810. In various embodiments, computing systems described herein, such as computing system 800, may include a conventional general purpose single-chip, multi-chip, single core or multiple core microprocessor such as a Pentium® processor, a Pentium® II processor, a Pentium® Pro processor, an xx86 processor, an 8051 processor, a MIPS® processor, a Power PC® processor, or an ALPHA® processor. In addition, the microprocessor may be any conventional special purpose microprocessor such as a digital signal processor.

The computing system 800 further includes a memory, such as random access memory (“RAM”) for temporary storage of information. As shown, in one embodiment, the memory comprises a 2 GB RAM 815. In certain embodiments, the computing system 800 further includes a read only memory (“ROM”) for non-volatile storage of information, and a mass storage device, such as a hard drive, solid state memory, diskette, or optical media storage device.

The example computing system 800 includes one or more commonly available input/output (I/O) devices and interfaces, such as a keyboard 845, mouse 840, touchpad, or printer. In one embodiment, the I/O devices and interfaces include a display device, such as a monitor 850 that allows the visual presentation of data to a user. The display device provides for the presentation of GUIs and application software data, for example. The computing system 800 may also include one or more multimedia devices, such as speakers, and microphones, for example.

The computing system 800 may also includes a graphics card, such as the 512 MB graphics card 820 (also referred to as a video card, graphics accelerator card, etc.) which generally outputs images to the display. In certain other embodiments the graphics card may be integrated on the motherboard.

Typically, components of the computing system 800 are connected to the computer using a standards based bus system. In different embodiments, the standards based bus system could be Peripheral Component Interconnect (“PCI”), Microchannel, SCSI, Industrial Standard Architecture (“ISA”) and Extended ISA (“EISA”) architectures, for example.

The computing system 800 also includes various software modules 825. For example, the computing system 800 includes, for example, an operating system such as, for example, Microsoft® XP 830. The computing system 800 may use other operating systems such as: Microsoft® Windows® 7, Windows® Vista, Windows® 3.X, Microsoft® Windows 95, Microsoft® Windows 98, Microsoft® Windows® NT, Microsoft® XP, Microsoft® Vista, Microsoft® Windows® CE, Palm Pilot OS, OS/2, Apple® MacOS®, Disk Operating System (DOS), UNIX, Linux®, VxWorks, or IBM® OS/2®, Sun OS, Solaris OS, IRIX OS operating systems, and so forth.

The computing system 800 can also include software which implements a portion of the EMS such as, for example, a venue service 835 and/or patron service 836, such as the venue service 135 and/or patron service 836 of FIG. 1, compatible with embodiments described herein. In certain embodiments, the venue service 835 and/or patron service 836 are executed by the CPU and include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Although disclosed in reference to a personal computer, ordinarily skilled artisans will recognize from the disclosure provided herein that the computing system 800 may be another type of computing system. For example, in certain embodiments, the computing system 800 comprises other hardware and/or software known to be suitable for servers. In certain embodiments. For example, in certain embodiments the computing system 800 may include HTTP server software (e.g., Apache), database server software (e.g., MySQL), or other server software.

In various embodiments, the computing system 800 comprises a laptop computer, a cell phone, a personal digital assistant, a kiosk, Blackberry® device, game console, or an audio player, for example. In other embodiments, the computing system 800 is another type of portable computing device, a computer workstation, a local area network of individual computers, an interactive wireless communications device, a handheld computer, an embedded computing device, or the like.

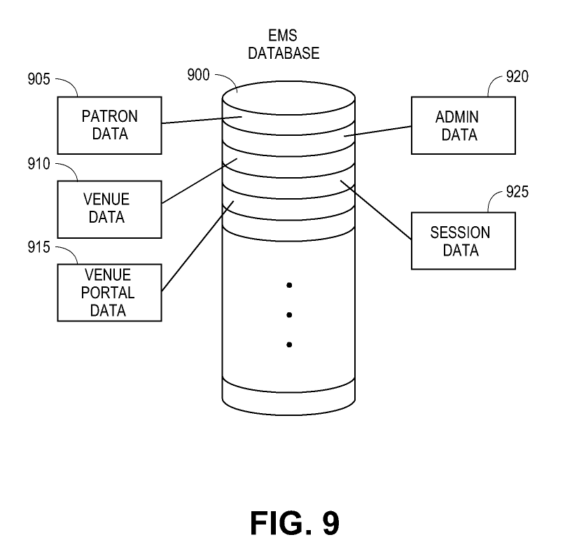

FIG. 9 illustrates a high-level diagram of an example EMS 900 in accordance with certain embodiments described herein. While many different organizational schemes may be utilized for the EMS database 900, in certain embodiments, the database 900 is organized into the following categories of data. Certain example types of data are described for each category. In certain embodiments, the EMS 900 may be organized into a number of separate data tables associated with the types of data described, or other types of appropriate data.

| TYPE OF DATA | DESCRIPTION |
|---|---|
| PATRON DATA | Patron data 905 can include a wide variety of information relating to |
| | EMS patrons. For example, patron data 905 can include records for |
| | each patron having an account or otherwise associated with the EMS. |
| | Each record can be identified by a unique id associated with the |
| | particular patron, for example. Each record can include profile |
| | information related to the patron. Such profile information can include |
| | personal information such as, without limitation: name; gender; an |
| | image to display on their EMS profile page; birth date; interests; |
| | profession, account status (e.g., active, banned, last access, permission |
| | levels, etc.), events the patron is associated with, etc., favorites such as |
| | favorite books, movies, music, television shows, etc. Patron data 905 |
| | can further include tables related to certain EMS events that the user is |
| | associated with. Patron data 905 records can further include |
| | information such as whether the user has accounts with particular |
| | types of third party applications and services such as applications or |
| | services provided by Yahoo, Skype, Facebook, Google, etc. Particularly |
| | where the EMS is capable for use in a restaurant context, the patron |
| | data 905 records may include F&B related information including: |
| | preferred restaurants, diet restrictions, allergies, preferred ingredients, |
| | food and beverage likes, dislikes and favorites, other EMS patrons or |
| | groups of patrons in the patrons EMS social network, etc. In one |
| | embodiment, the Patron data 905 includes a FRIEND table that |
| | includes the unique patron id of each patron that is a “friend.” In |
| | addition, in one embodiment, the Patron data 905 includes payment |
| | source information for a patron, such as credit card information (e.g., |
| | card type, card number, security code, expiration date, full name, |
| | billing address) or alternative sources of payment, such as, for |
| | example, debit card, PAYPAL account information, etc. |
| VENUE DATA | Venue data 910 includes data related to venues having EMS accounts. |
| | For example, the EMS database 900 may include a venue data 910 |
| | record associated with each registered venue. Venue data can include, |
| | for example, any of the following: venue type, description, hours, |
| | location or locations; website; logo; description; contact information; |
| | services, products or other offerings provided by the venue and |
| | associated prices; reviews associated with the venue or with particular |
| | venue offerings; EMS account information for the venue (e.g., account |
| | status, employees authorized for EMS administration access, etc.). As |
| | an illustrative example, in a restaurant context the venue data 915 may |
| | include, without limitation: currently available menu offerings; |
| | ingredients, prices, images, recipes, reviews, and the like associated |
| | with each menu offering or group of menu offerings; reviews and/or |
| | ratings associated with the restaurant (e.g., overall ratings or ratings |
| | related to service, food, atmosphere, etc.). Where a chain of restaurants |
| | are registered with the EMS, chain-wide information may be included |
| | in the venue data 910. Such information may include identifiers linked |
| | to EMS records for each restaurant in the chain, chain-wide menu |
| | offerings, promotional offerings, venue employees authorized access to |
| | chain-wide EMS data, venue employees authorized to access EMS data |
| | associated with specific restaurants in the chain, etc. |
| VENUE PORTAL | In certain embodiments, venue portal data 915 includes information |
| DATA | associated with the EMS portal for a particular venue. Such |
| | information can include information associated with the venue that is |
| | generally not accessible to patrons through the EMS, for example. In |
| | various embodiments, venue portal data 915 includes alert criteria |
| | which may define rules for triggering EMS issued alerts to venue |
| | employees (e.g., when a VIP enters a venue, or when there is a service |
| | issue identified via patron feedback) or for taking other actions. In one |
| | embodiment, venue portal data 915 includes payment types (e.g., types |
| | of credit cards) accepted by the venue. In other embodiments, the |
| | venue portal data 915 is stored along with the venue data 910 and is |
| | not organized into a separate category. |
| ADMIN DATA | Admin data 920 can include records relating to EMS administration |
| | and configuration. For example, admin data 920 may be organized into |
| | records for individual EMS administrators, such as venue employees |
| | authorized to access the EMS (e.g., chain managers, restaurant |
| | managers, etc.), administrators authorized to administer the EMS |
| | servers and/or database, etc. Such records can include information |
| | related to the authorized users such as login information, name, email, |
| | phone number, etc., and may be linked to the particular venue or chain |
| | of venues they are associated with. |
| SESSION DATA | Session data 925 can include records storing information related to |
| | EMS sessions such as patron and/or venue administrator EMS |
| | sessions. For example, a session can include an EMS client session |
| | where a session is established between an EMS client running on a |
| | patron's mobile device and an EMS server, for example. Other types of |
| | sessions may include sessions established between an administrator |
| | interface of a venue computing device and an EMS server, for |
| | example. |

In certain embodiments, the EMS database 900 may include all of the categories and/or types of data described above, a subset thereof, or may include additional categories and/or types of data and associated records and tables. The information in the database 900 may be organized differently in various embodiments. For example, in certain embodiments, some or all of the information described as included in venue portal data 915 is instead included in venue data 910. Additionally, in certain embodiments, as will be appreciated by those of skill in the art, different portions of the database 700 may be physically stored on different computers, such as different physical servers associated with the EMS.

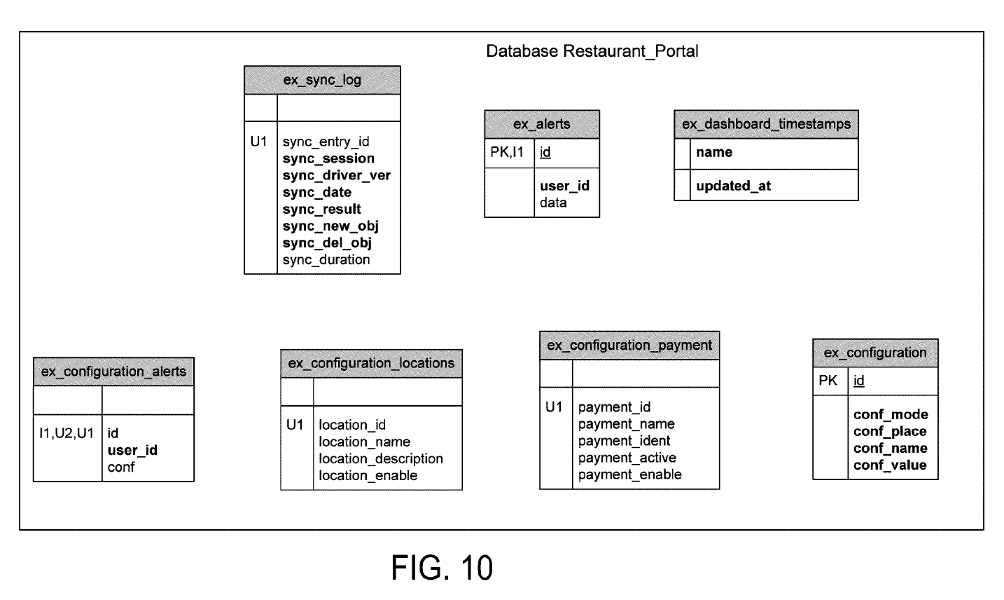

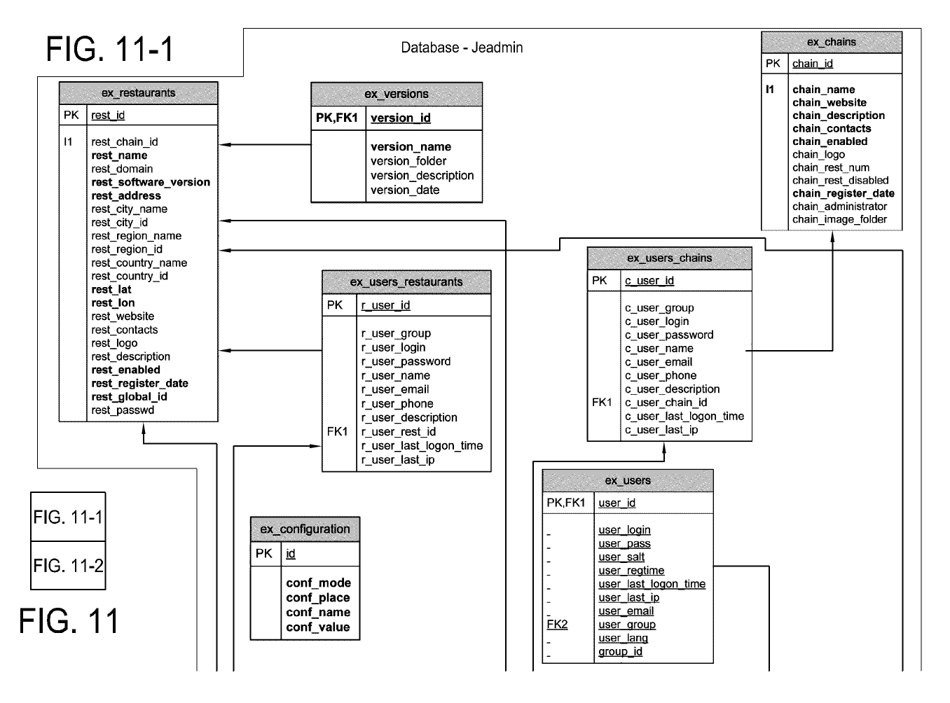

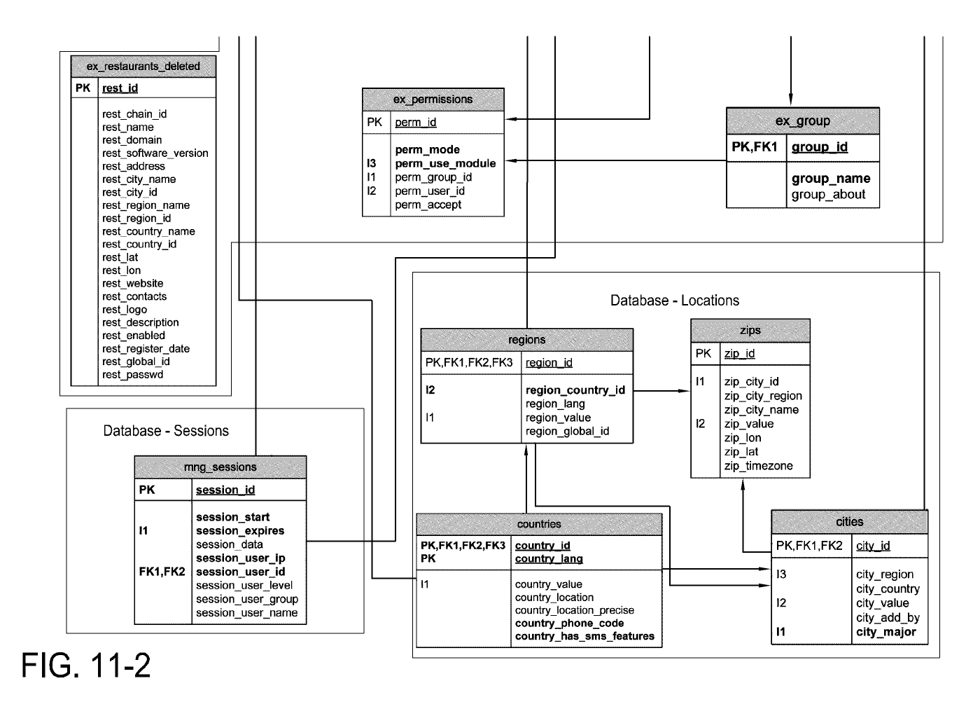

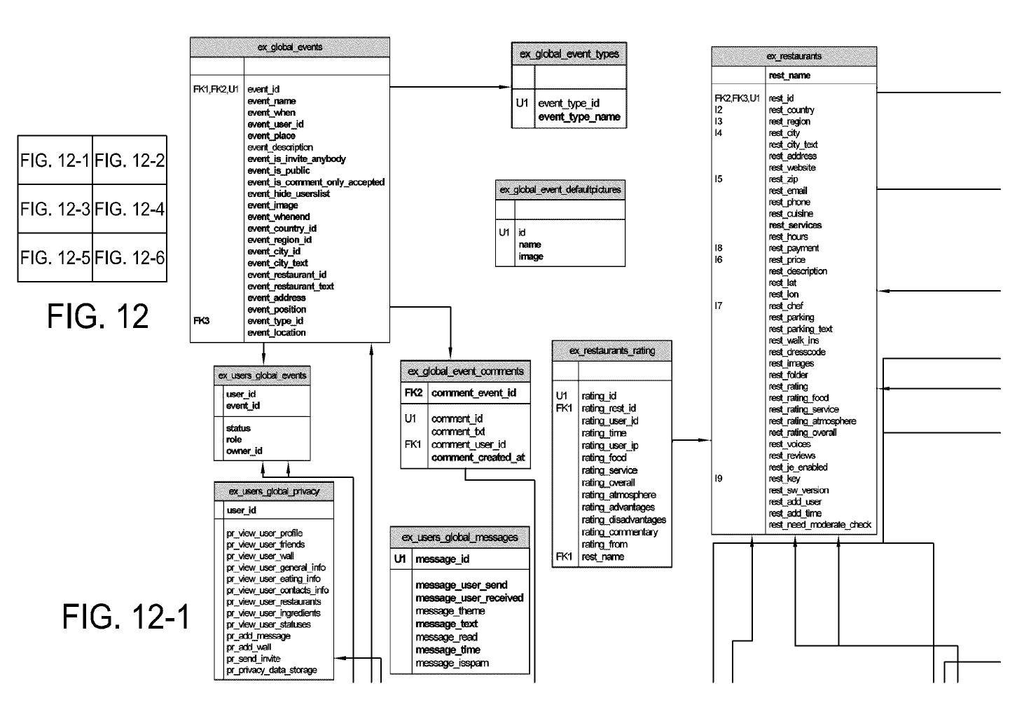

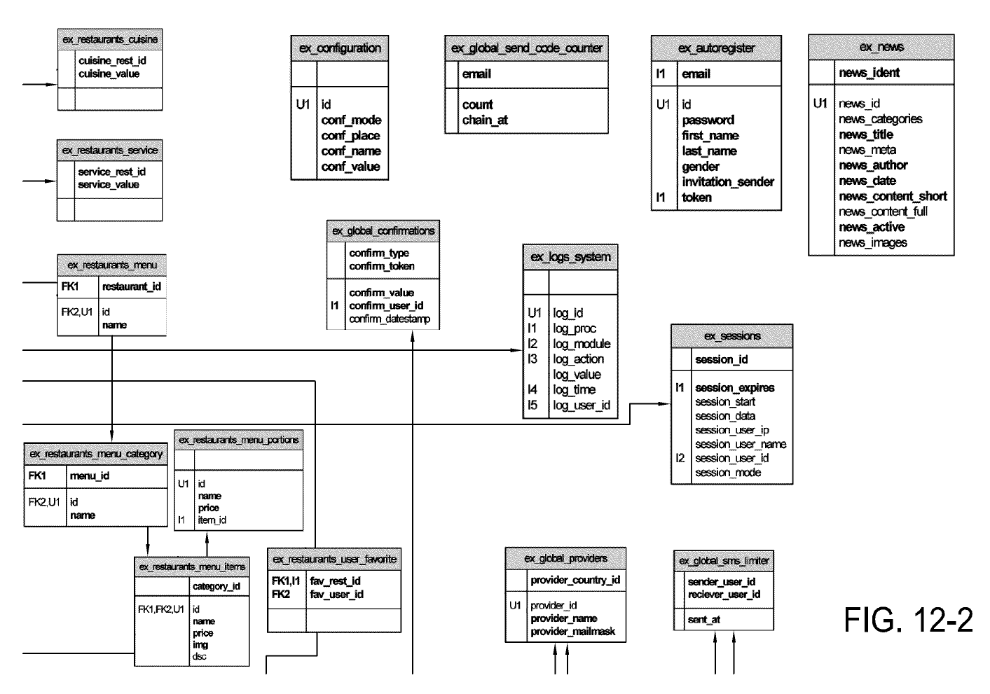

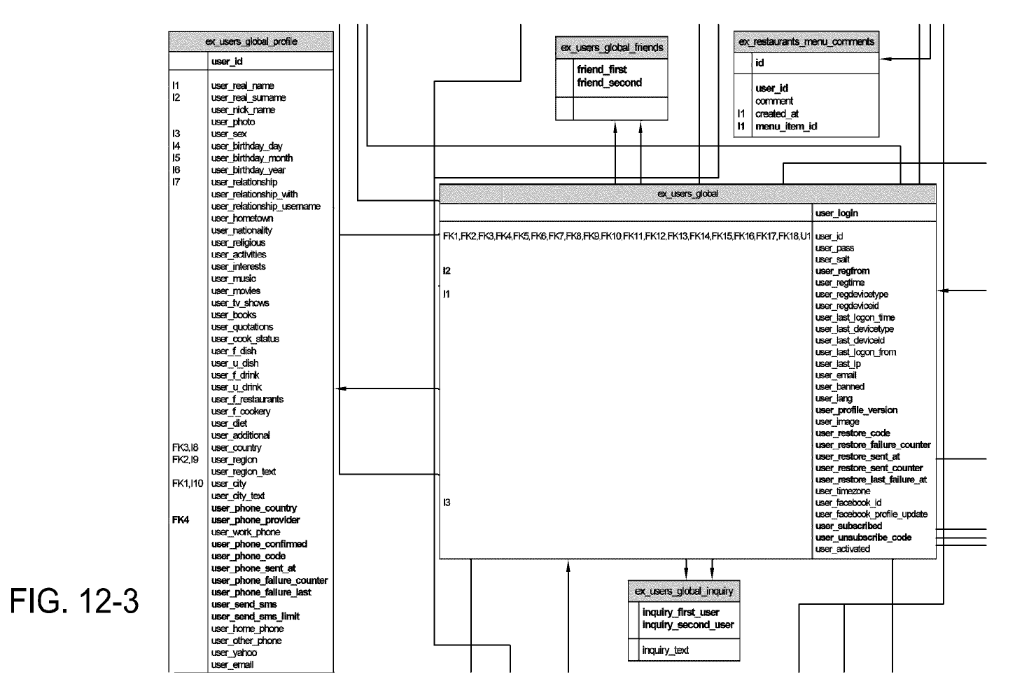

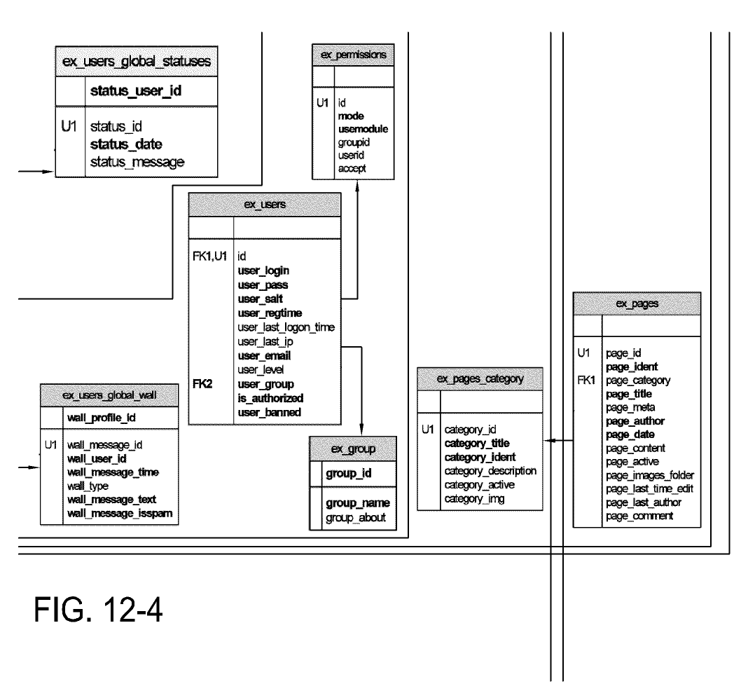

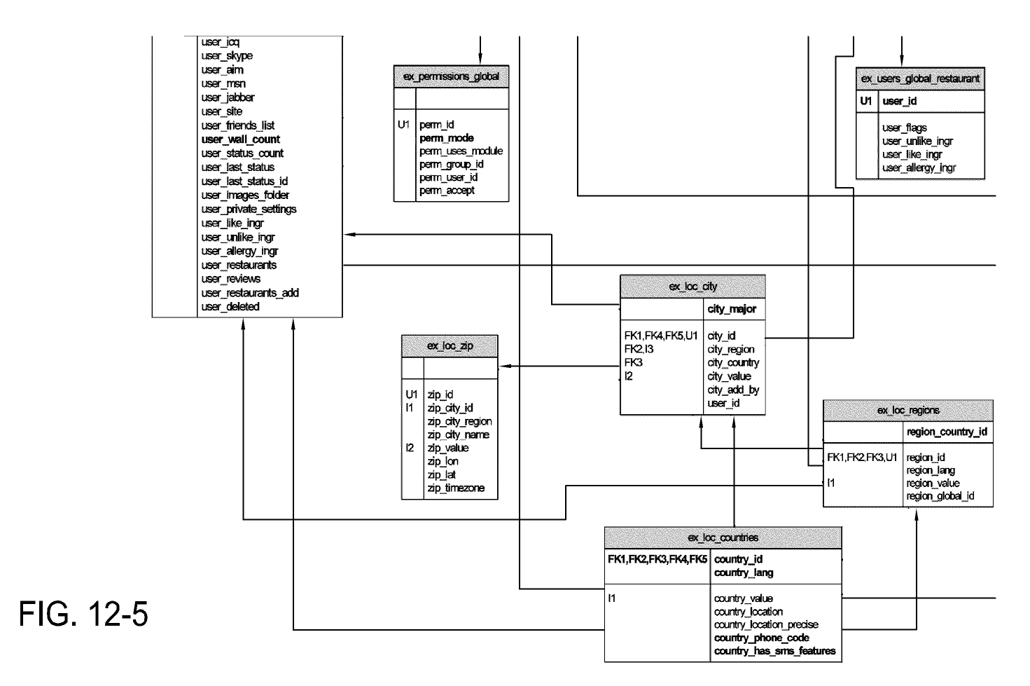

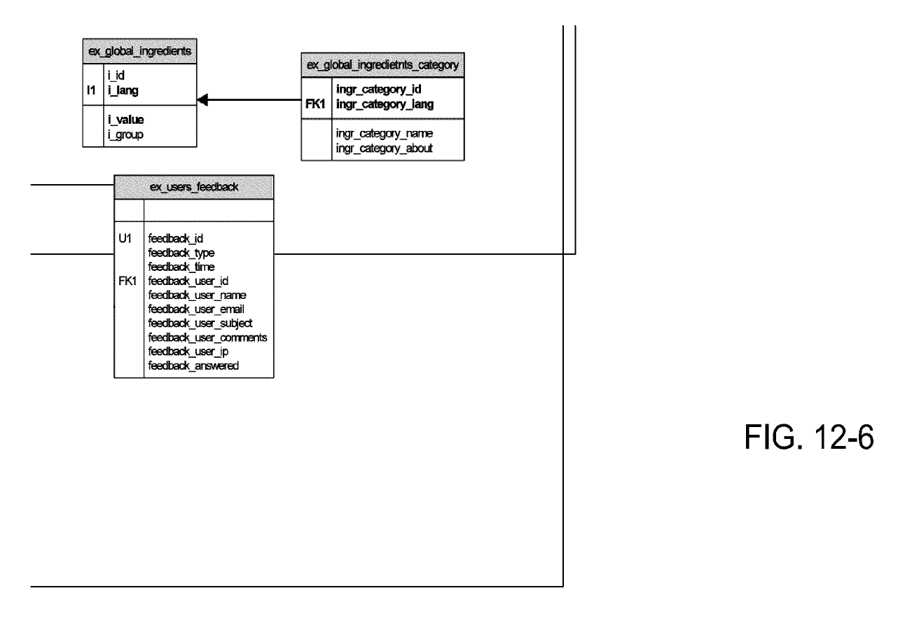

Although a variety of database configurations are possible, FIGS. 10, 11 (including 11-1 and 11-2) and 12 (including 12-1, 12-2, 12-3, 12-4, 12-5 and 12-6) illustrate relational database diagrams of an example experience management database in accordance with certain embodiments described herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Depending on the embodiment, certain acts, events, or functions of any of the methods described herein can be performed in a different sequence, can be added, merged, or left out all together (e.g., not all described acts or events are necessary for the practice of the method). Moreover, in certain embodiments, acts or events can be performed concurrently, e.g., through multi-threaded processing, interrupt processing, or multiple processors or processor cores, rather than sequentially.

The various illustrative logical blocks, services, modules, circuits, and algorithm steps described in connection with the embodiments disclosed herein can be implemented as electronic hardware, computer software, or combinations of both. To clearly illustrate this interchangeability of hardware and software, various illustrative components, blocks, services, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, services, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal. The terms service and module are used interchangeably herein.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

1. An electronic method of providing a personalized experience to patrons of food and beverage (F&B) venues, comprising:
receiving patron data associated with a plurality of patrons;
receiving venue data associated with a plurality of F&B venues;
receiving, at least one server, a request from a first patron to view a menu associated with a first venue of the plurality of F&B venues; and
generating, using a processor of the server, a personalized menu for display to the first patron based on patron data associated with the first patron and venue data associated with the first venue, the personalized menu including at least one F&B offering.

2. The method of claim 1, wherein the patron data associated with the first patron includes information relating to previous purchases the patron has made at the first venue.

3. The method of claim 1, wherein the patron data associated with the first patron includes information relating to one or more food or beverage preferences provided by the first patron.

4. The method of claim 1, wherein the request is received from a handheld device associated with the first patron.

5. The method of claim 1, wherein the personalized menu is generated for display to first patron on the handheld device and is interactive such that a user can select one or more F&B offerings by interacting with the personalized menu.

6. The method of claim 5, further comprising receiving, at the server, data indicative of at least one F&B purchase selection made by the first patron, the purchase selection made by the patron using the personalized menu.

7. The method of claim 6, further comprising allowing payment to be collected from the first patron by the venue for the at least one F&B purchase selection.

8. The method of claim 7, wherein the patron data associated with the first patron includes payment information, and the allowing step comprises sending at least a portion of the payment information to the first venue.

9. The method of claim 1, wherein the first patron data includes service information related to the first patron, the method further comprising causing at least a portion of the service information to be communicated to personnel of the first venue for use in providing personalized service to the first patron.

10. The method of claim 1, further comprising:
receiving, at the server, location information associated with a handheld device of the patron; and
determining an estimated arrival time of the first patron based on the location information.

11. The method of claim 1, further comprising:
detecting an alert triggering event; and
causing an alert to be communicated to a person associated with the venue in response to the alert triggering event.

12. The method of claim 1, wherein the alert triggering event comprises the arrival of the first patron.

13. An electronic method of providing a personalized experience to patrons of food and beverage venues, comprising:
receiving first patron data associated with a first patron, the first patron data indicative of a first preference;
receiving second patron data associated with a second patron, the second patron data indicative of a second preference;
receiving first venue data associated with a first food and beverage venue, the first venue data indicative of a first product offered by the first food and beverage venue, and the first venue data also indicative of a second product offered by the first food and beverage venue;
receiving, at a network connection of a server, first menu request data, the first menu request data representing a request from the first patron to view a menu associated the first food and beverage venue, and the first menu request data also representing a first network address associated with a first computing device associated with the first patron;
comparing, using a processor of the server, the first patron data with the first venue data to generate first product selection data, the first product selection data representing the first product and not the second product;
formatting the first product selection data to create first menu data, the first menu data representing a first personalized menu descriptive of the first product; and
transmitting the first menu data to the first network address.

14. The method of claim 13, further comprising:
receiving, at the network connection of the server, second menu request data, the second menu request data representing a request from the second patron to view a menu associated with the first food and beverage venue, and the second menu request data also representing a second network address associated with a second computing device associated with the second patron;
comparing, using a processor of the server, the second patron data with the first venue data to generate second product selection data, the second product selection data representing the second product and not the first product;
formatting the second product selection data to create second menu data, the second menu data representing a second personalized menu descriptive of the second product; and
transmitting the second menu data to the second network address.

15. A system for providing a personalized experience to patrons of food and beverage venues, comprising:
at least one processor;
a first storage in communication with the at least one processor, the first storage storing first patron data associated with a first patron, the first patron data indicative of a first preference, the first storage storing second patron data associated with a second patron, the second patron data indicative of a second preference, the first storage storing first venue data associated with a first food and beverage venue, the first venue data indicative of a first product offered by the first food and beverage venue, and the first venue data also indicative of a second product offered by the first food and beverage venue;
a communication port configured to receive first menu request data, the first menu request data representing a request from the first patron to view a menu associated with the first food and beverage venue, and the first menu request data also representing a first network address associated with a first computing device associated with the first patron; and
a menu generation module comprising software instructions stored on the first storage and executable by the at least one processor to compare the first patron data with the first venue data, and to generate first product selection data, the first product selection data representing the first product and not the second product, and to process the first product selection data to create first menu data, the first menu data representing a first personalized menu descriptive of the first product, and to cause the first menu data to be transmitted via the communication port to the first network address.

16. The system of claim 15, wherein the communication port is further configured to receive second menu request data, the second menu request data representing a request from the second patron to view a menu associated with the first food and beverage venue, and the second menu request data also representing a second network address associated with a second computing device associated with the second patron, and wherein the menu generation module further executable by the at least one processor to compare the second patron data with the first venue data to generate second product selection data, the second product selection data representing the second product and not the first product, and to process the second product selection data to create second menu data, the second menu data representing a second personalized menu descriptive of the second product, and to cause the second menu data to be transmitted to the second network address.

17. The system of claim 15, further comprising:
a location determination module comprising software instructions stored on the first storage and executable by the at least one processor to determine a location of the first computing device.

18. The system of claim 17 wherein the location determination module is further executable by the at least one processor to determine an estimated arrival time of the patron at the first food and beverage venue.

19.-25. (canceled)
